(19) United States
(12) Patent Application Publication
(10) Pub. No.: US 2002/0030637 A1
(43) Pub. Date: Mar. 14, 2002

(54) Aremac-based means and apparatus for interaction with computer, or one or more other people, through a camera

(76) Inventor: W. Stephen G. Mann, Toronto (CA)

Correspondence Address: W. Stephen G. Mann, Suite 701, 284 Bloor Street West, Toronto, ON, M5S 3B8, CA

(21) Appl. No.: 09/987,768

(22) Filed: Nov. 15, 2001

(30) Foreign Application Priority Data
Oct. 29, 1998 (CA) 2,248,473
Dec. 31, 1998 (CA) 2,256,922
Mar. 15, 1999 (CA) 2,264,973
Jul. 28, 1999 (CA) 2,280,022
Dec. 24, 1998 (CA) 2256918
Aug. 29, 2000 (CA) 2316098

(51) Int. Cl. G09G 5/00

(52) U.S. Cl. 345/8

(57) ABSTRACT

A new kind of display means and apparatus called an aremac is provided. The aremac may either be worn upon the body, such as in a pair of eyeglasses, where it can direct light into an eye of the wearer of the apparatus, or it may be located together with a fixed camera to direct light onto a three dimensional scene or objects. The typical application of the aremac is that of collaborative photography, in which a remote director assists a photographer in composing a picture, or arranging lighting in a photographic studio while the remote director remotely views the scene through the photographer's camera. In a wearable embodiment, the camera is effectively imaged inside an eye of the wearer so that the remote director can view the light rays passing through an eye of the wearer of the apparatus and the director can write on the retina of the wearer of the apparatus by pointing a laser beam at the screen in the director's office, which teleoperates a miniature laser beam directed through the wearer's eye lens onto the retina of an eye of the wearer in such a manner that when the director points at an object in the scene, the wearer of the apparatus sees a red dot at the corresponding location on that same object. In another embodiment, the remote director can point to objects in the photographer's studio by pointing a laser beam at a projection screen which displays images of these objects in the photographer's studio, where the director's laser pointer remotely controls a teleoperated laser pointer in the photographer's studio.

### FIELD OF THE INVENTION

The present invention pertains generally to a new display device that a photographer or person doing a task such as photography, may use for interaction with a computer, or with one or more other people at one or more remote locations, by way of using the camera as a back channel to complete a interactional communications loop.

### BACKGROUND OF THE INVENTION

In photography (and in movie and video production), as well as in many other tasks such as fixing an automobile, baking a cake, or shopping for groceries at the supermarket, it is desirable to collaborate with one or more remote experts. For example, while shopping for a new car, it would be nice to be able to collaborate with a spouse at a remote location, in such a manner that the remote spouse could participate both by shared viewpoint, and the ability to collaborate by calling attention to certain objects in the environment, such as being able to call attention to one of the levers on the steering column, in such a way that it is clear to both parties, which of the many levers is being discussed.

Traditional telephony fails to provide such detailed shared visual space. Similarly, even video conferencing such as portable video conferencing laptop computers fail to provide convenient means of interacting as would exist if both people were in the same space. For example, when people are together, one person will often point at objects to indicate to the other which object is being referred to. Laser pointers are often used for this purpose when the finger will not reach or is inconvenient. For example, construction workers in the same space will often use laser pointers to point at pipes up on the ceiling when the pipes are close together and it would be ambiguous which one is being pointed at by hand.

### SUMMARY OF THE INVENTION

### Objects and Advantages

It is an object of this invention to provide a display system in which the display is visible in any depth plane, and in fact has essentially infinite depth of focus.

A feature of the invention is that a display is provided where the display has essentially infinite depth of field, so that it can create a computer-mediated reality environment in which virtual objects appear at various depth planes to correspond to the depth planes of real objects.

A feature of the invention is that it provides collaboration between a photographer and a remote manager.

A feature of the invention is that it provides a remote manager with the ability to look at the light passing through an eye of the wearer of a wearable apparatus and write upon the retina of an eye of the wearer of the apparatus while looking at this light projected upon a screen at a remote location.

A feature of the invention is that an eyetap perspective, e.g. the center of projection of an eye of the wearer, can be recorded in a natural manner so that still pictures or video recorded with the apparatus of the invention may better capture everyday experiences such as the opening of a gift, a baby's first steps, or the natural excitement of a bride and groom at a wedding, where the pictures or video are captured in a manner that is free of the obvious contrived nature typical of traditional wedding photography or the like.

A feature of the invention is that it may embody a device called an aremac, where an aremac is a device that may project light into the eye on more than just one depth plane (e.g. an aremac is to a projector as a camera is to a flatbed scanner, and thus an ordinary display such as a television is a special case of an aremac where the view is limited to a single depth plane).

A feature of the invention is that an eyetap camera may be aimed with the aid of a remote manager providing aiming reticle, graticule, crosshairs, and other markings upon the retina which has infinite depth of field on account of the use of an aremac.

A feature of the invention is that when a pinhole camera is used in conjunction with an aremac, approximately infinite depth of field may be attained, so that collinearity is satisfied, that is, any given outgoing ray of virtual light is collinear with the incoming ray of real light that generated it.

A feature of the eyetap camera invention is that a diverter is used to locate the effective camera position inside an eyeball of the wearer.

An important aspect of the proposed invention is the capability of the apparatus to partially mediate (augment, and to a limited extent diminish, or otherwise alter) the visual perception of reality, and to allow others to alter the user's visual perception of reality.

It is possible with this invention to provide the user with a means of determining the composition of the picture from a display device that is located such that only the user can see the display device, and so that the user can ascertain the composition of a picture or take a picture or video and transmit image(s) to one or more remote locations without the knowledge of others in the immediate environment, or at least without appreciably distracting others in the immediate environment.

It is possible with this invention to provide a means for a user to experience additional information overlaid on top of his or her visual field of view such that the information is relevant to the imagery being viewed.

It is possible with this invention to provide a means for a user to shoot still pictures or video with a wearable camera system while using the help of a remote intelligence collective.

It is possible with this invention to provide a means for a user to shoot still pictures or video in a studio setting, while using the help of a remote team of experts, art directors, or the like.

It is possible with this invention to shoot a documentary video about video surveillance while drawing on the expertise of a remote panel of legal experts, videographic experts, and the like, as well as drawing on the assistance of a mechanism for finding hidden video surveillance cameras, and it is possible to make all this expertise take the form of a computer-mediated reality environment.

### SUMMARY OF THE INVENTION

### Informal Review of What the New Invention Does

The proposed invention facilitates interaction between an individual user of a camera and a remote expert, or remote panel of experts, or possibly a computer program which is itself an expert, such as a computer system that can detect hidden video surveillance cameras or recognize buildings and other objects.

An important feature of the invention is the use of a new display means called an “aremac”. The aremac conveys information by altering the visual perception of reality experienced by its user.

The aremac is to a camera as a projector is to a scanner. The aremac forms images with non-zero depth of focus, so that it can either form images on various objects in a room, or form images on the retina of an eye of a person looking at these various objects in various depth planes. In some forms, the aremac has essentially unlimited depth of focus.

The most common application of the aremac is in collaborative photography, most notably, the “painting with lightvectors” genre of photography called dusting, in which a camera is pointed at a scene, and a photographer collects multiple exposures of the same scene or object under different illumination. Each of these exposures is called a “lightvector”, and collectively, the exposures define a “lightvector subspace”.

Typically there is a camera that takes the picture of the scene being dusted (“painted”), and a remote operator (director) signals to various objects in the scene by pointing at them with an aremac. The aremac typically is simply a laser beam with galvos to aim it so that it can either point at one object with a small dot, or can write text messages or simple raster graphics on various objects so that the photographer can see these messages.

For example if the photographer is dusting a large building, the director will have a view of the camera image upon a large projection TV screen so that she can have a good look at it, and annotate it, etc., perhaps together with a small team of people looking at the image for artistic content, composition, and general tonal balance. The director might for example convert the image into different colour spaces and inform the photographer of certain colour gamut warnings. If, for example, the blue colour above a certain arched doorway is not quite in range, she may point the laser beam that way, so the photographer can see a dot there, and she will describe the situation. Alternatively, she may display her message in simple vector graphics with the laser beam, so she will circle the offending area on the building, and draw a small arrow there, indicating that she changed one of the blue lightvectors to cyan for better reproduction in CMYK colour space. She will generally do this by writing in the vector components by hand, using a laser pointer, and capturing to send to the aremac. She might write something like “Changed v101 to [0 1 1 ]; [0 0 1] is greying CMYK-Betty”, and this message will appear to the photograher to hover above the curved arch of the building's main doorway.

It should be noted that this style of photography, called dusting, differs from traditional photography. In traditional photography the lights are mounted on light stands, and the photographer usually holds the camera by hand and walks around with a small transmitter like the one called a “FlashWizard” made by LPA design. Each flash usually has a receiver, and fires when the camera transmits to fire the flashes. The FlashWizard transmitter has a belt clip while the receiver does not, because this is how they expect their product to be used.

However, in dusting, the opposite is true. The camera is normally fixed on a tripod, and the photographer carries a flash lamp and holds this by hand. The photographer walks around the scene and flashes at various parts of the scene, each flash resulting in a separate file starting from v000.jpg to as high as v999.jpg if there are, for example, 1000 dusts. Each dust produces a new file.

As the photographer is dusting, the laser aremac images will be visible on various parts of the building, but if, for example, the photographer goes inside the building to backlight one of the windows from inside, all the messages that were written on the face of the building will no longer be visible to the photographer.

In fact even if outside, the messages will be keystoned or distorted unless the photographer is standing right where the camera is located.

When the photographer stands near the camera the messages are all in roughly the same coordinates as the director sees them in (and hence writes them in).

This phenomenon of distortion is well known to anyone who has operated a circular followspotlight. The followspot operator always sees a circle, regardless of what the light is shining on, even though others see an ellipse if it is shining on an oblique surface or a broken disjoint shape if it is shining on a series of disjoint surfaces such as stairs or open doorways.

For this reason, as well as for other reasons, the photographer therefore often wears a head mounted display (HMD) of some sort which provides a remote viewfinder effect, so that the photographer and director are both looking at what the camera sees. However, since the photographer would like to see the viewfinder and see real world objects (like the stairs he is climbing, or the ladder he is climbing up to the roof of the building), the viewfinder he wears often needs to have a focus knob.

Many camera viewfinders have a focus knob but for a completely different reason. The usual stated reason that viewfinders have a focus knob is so that people who normally wear corrective eyewear can dial in their prescriptions and see through the viewfinder without the need for eyeglasses. However, in the context of the present invention, it is desired that the real world objects be in the same depth plane as the virtual objects, just as they would be if written on the real world objects with a laser beam from a scene based aremac.

Accordingly, an alternative embodiment of the invention involves the use of an aremac that writes upon the retina of an eye of the wearer, typically by using a laser point source and spatial light modulator. This alternative embodiment is called an EyeTap (TM) aremac.

When using the EyeTap aremac, there is no need for a focus knob on the display system, because it is always in focus no matter where the eye is focused. Even if the wearer of the EyeTap aremac takes off his glasses or puts on glasses having an incorrect prescription, when looking into the EyeTap aremac everything is in sharp focus.

Thus the wearer of the EyeTap aremac can see his director's messages in perfect focus while reading a newspaper at close range (the messages will appear to hover over the newspaper) or while looking up at the stars in the sky in which case the messages will appear to hover up in the sky with the stars.

Thus the EyeTap aremac embodiment and the scene aremac embodiment of the invention are both equivalent in this regard, in the sense that computer-generated (synthetic) objects are always in sharp focus upon the actual objects to which they refer, regardless of the fact that these actual objects may be at different distances (and hence different foci) from the photographer.

Normally a camera has an f-stop so that everything in the scene can be brought into focus by choosing a small enough f-stop. Thus the photographer can see everything through the camera as being in focus. However, viewfinders never have f-stops, and therefore they have very limited depth of field. The fact that viewfinders don't have f-stops is one reason for the invention being far superior to using a viewfinder as a shared visual annotation space.

Moreover, sharing space upon the retina of the photographer's eye, or upon the actual subject matter being photographed (the two being equivalent as far as the photographer perceives them), is a much more effective way to collaborate. The invention is useful for more than just photography, and in fact, one may place a camera in one's garage, above the car, so that one can open up the hood, and summon remote advice on how to fix the engine. This would of course facilitate the production of a documentary video on how to fix an automobile engine, but it needn't do so. In other words, the camera can be used even if the goal is not to take pictures.

While shopping at the grocery store, a photographer can look at apples on the shelf, and his wife at home can turn on her computer and visit his WWW page and see whatever he is looking at. One example of this kind of interaction was implemented as something called “Wearable Wireless Webcam” at http://wearcam.org and allowed people to remotely visit the view of an eye of the wearer of the apparatus, and to write messages upon the retina of an eye of the wearer of the apparatus.

Although one purpose of this invention is to help in making documentary videos, the invention may be of use to those who simply want to collaborate across vast distances even if there is no interest in taking pictures. The camera can be used by someone who wants his wife to remotely see inside the car he's planning on buying, so that she can also draw on his retina to circle certain levers and controls in the car and ask him what they do.

Accordingly the present invention in one aspect comprises a head mounted display (HMD) which may be an ordinary commercially available HMD, which receives a video signal transmitted from a camera fixed in the environment, and where there is also a scene aremac in the environment together with the fixed camera.

According to another aspect of the invention, there is provided a console for communicating with a remote photographic studio containing camera and scene aremac, in which the console displays the video output of the remote studio camera and allows a director to point to the displayed image with a laser pointer causing the scene aremac to do exactly what the laser pointer does in terms of what object it points at.

According to another aspect of the invention, there is provided a system for using a laser pointer from a director's screenspace (office) as a user-interface to an aremac in a distant studio workspace containing camera and aremac.

According to another aspect of the invention, there is provided a conferencing system using a laser pointer as a user interface for tele-operation of a laser-aremac in a distant studio workspace containing camera and laser-aremac.

According to another aspect of the invention, there is provided an EyeTap aremac based on a point source of light directed into an eye of the user, rather than upon objects in a studio. Preferably the point source is a laser, and the apparatus is wearable, so that the apparatus directs laser light onto the retina of an eye of the wearer, giving the same appearance as if laser light were directed onto the scene itself upon which the wearer's eye is focused. Preferably the device contains a camera so that a remote director can monitor the video from the device and write onto the retina of the wearer to annotate objects the wearer is looking at. Preferably the camera has an effective location right in the eyeball of the wearer so that its center of projection is the same as a lens of an eye of the wearer, so that the camera will capture the exact bundle of rays passing through the lens of an eye of the wearer onto the retina. Preferably a remote director can view the light passing through an eye of the wearer and effectively write directly onto the objects so seen, by writing onto the retina of an eye of the wearer of this apparatus.

According to another aspect of the invention, there is provided a wearable camera system including an optical system that projects the effective location of the camera right into an eye of the wearer of the camera, so that the camera is effectively partially located in the eye socket of the wearer, such that its center of projection is actually that of the wearer's eye itself. Preferably a remote director has a view looking out through this camera, so that the remote director shares the exact same view as the wearer of the camera. Preferably the wearer of the camera also wears an aremac responsive to an output signal from the remote director's scanner of the remote director's laser pointer.

According to another aspect of the invention, there is provided a wearable camera system including an optical system that projects the effective location of the camera right into an eye of the wearer of the camera, together with a spatial light modulator providing the wearer with a video display. Preferably the video display is responsive to a remote director having a view looking out through this camera.

According to another aspect of the invention, there is provided a wearable video conferencing system allowing a remote operator to send visual data to the wearer by using a laser pointer as an input device. Preferably there is an intelligence collective to support the wearer of the camera.

According to another aspect of the invention, there is provided a motion stabilized teleoperation with a laser pointing system.

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1 illustrates the scene aremac in relation to other known devices.

FIG. 2 illustrates the use of the invention to collaborate with a remote director who assists the photographer in the dusting genre of photography.

FIG. 3 illustrates an alternate director's console.

FIG. 4 illustrates how telepointing works to control an aremac with a laser pointer.

FIG. 5 shows an intelligence collective prepared to assist a photographer using a wearable camera with wearable aremac.

FIG. 6 shows some signal to noise ratio improvements to the telepointing system.

FIG. 7 shows a wearable collaboration and communications system.

FIG. 7a shows a close-up depicting means for aremac EyeTapping.

FIG. 7b shows a close-up depicting means for aremac EyeTapping together with exclusion of higher diffractive orders arising from periodicity of a spatial light modulator.

FIG. 8 shows an embodiment of the invention built into eyeglasses.

FIG. 9 shows a portable embodiment of the invention that does not need to be worn on the head.

FIG. 10 shows an embodiment of a wearable scene aremac system used to laser point to hidden video surveillance cameras.

FIG. 11 shows an embodiment of the invention in which humanistic intelligence (HI) is used to correct for camera-aremac parallax.

### DETAILED DESCRIPTION OF THE PREFERRED EMBODIMENTS

While the invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

In all aspects of the present invention, references to “camera” mean any device or collection of devices capable of simultaneously determining a quantity of light arriving from a plurality of directions and or at a plurality of locations, or determining some other attribute of light arriving from a plurality of directions and or at a plurality of locations. Similarly references to “photographer” shall not be limited to just a person taking pictures, but shall include a person using a camera for the purposes of collaboration on a task that need not necessarily result in the production of a visual record.

References to “processor”, or “computer” shall include sequential instruction, parallel instruction, and special purpose architectures such as digital signal processing hardware, Field Programmable Gate Arrays (FPGAs), programmable logic devices, as well as analog signal processing devices.

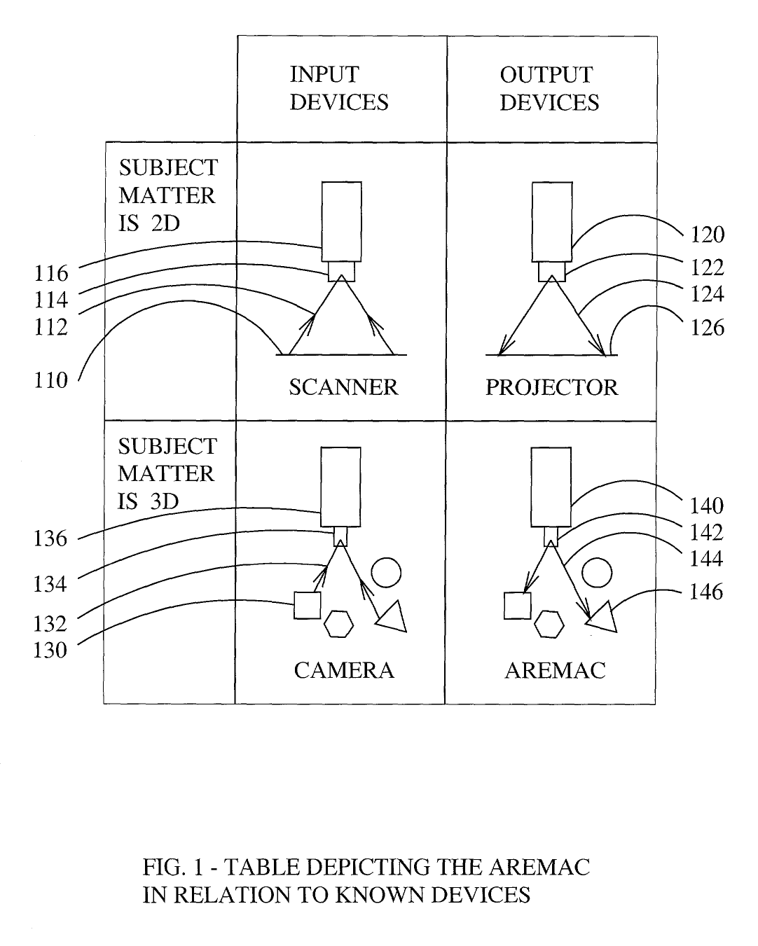

FIG. 1 is a tabular figure defining the aremac in relation to known devices, the known devices being the scanner, the projector, and the camera. There are various kinds of scanners. Some scanners work in a manner similar to photocopiers while others comprise a sensor array mounted in a box on a copy stand where a flat object can be placed. For purposes of explanation, consider the copy-stand embodiment of the scanner. The copy-stand embodiment of the scanner, depicted in the figure, is commonly used to record the image from a flat object such as the page of a book, 110, by way of light 112 bouncing off the flat object, and entering a lens 114, into the scanner body 116. The scanner receives and records light from a two dimensional (2D) object. The projector transmits and displays light onto a 2D object. A projector 120 is typically fitted with a lens 122, which directs light 124 onto a projection screen, or flat wall (usually light in color) 126. The camera receives and records light from one or more three dimensional (3D) objects. Objects 130 scatter ambient light from the environment, or light from artificial sources, 132, and lens 134 attached to camera 136 forms an image of the objects 130 inside the camera 136, where the image is recorded or transmitted to a remote location for storage or remote observation. A camera may take pictures of 2D objects like the scanner does, but it is important to realize that the camera has sufficient depth of field to capture pictures of 3D objects. The aremac 140 typically comprises optics 142 which direct light 144 at a 3D scene 146. In this way the aremac is to the camera as the projector is to the scanner. Similarly, the aremac may project light onto 2D or 3D scenes, but it is important to realize that the aremac has sufficient depth of field to project onto 3D objects and scenes.

The aremac may also project light directly into the eye, for example, if appropriately designed, the aremac may shines light directly into the eye, and images can be formed on the retina of the eye. With good aremac design, these images can appear in sharp focus in any depth plane that the eye is capable of focusing on. In this case, the aremac will produce virtual light (converging rather than diverging rays of light) so that all the rays of light meet at a bundle. Such a well designed aremac will thus have sufficient depth of field that it may be directed into the eye by way of a beamsplitter, to superimpose virtual light upon the field of view of the eye, regardless of where and at what distance the eye is focused in that field of view.

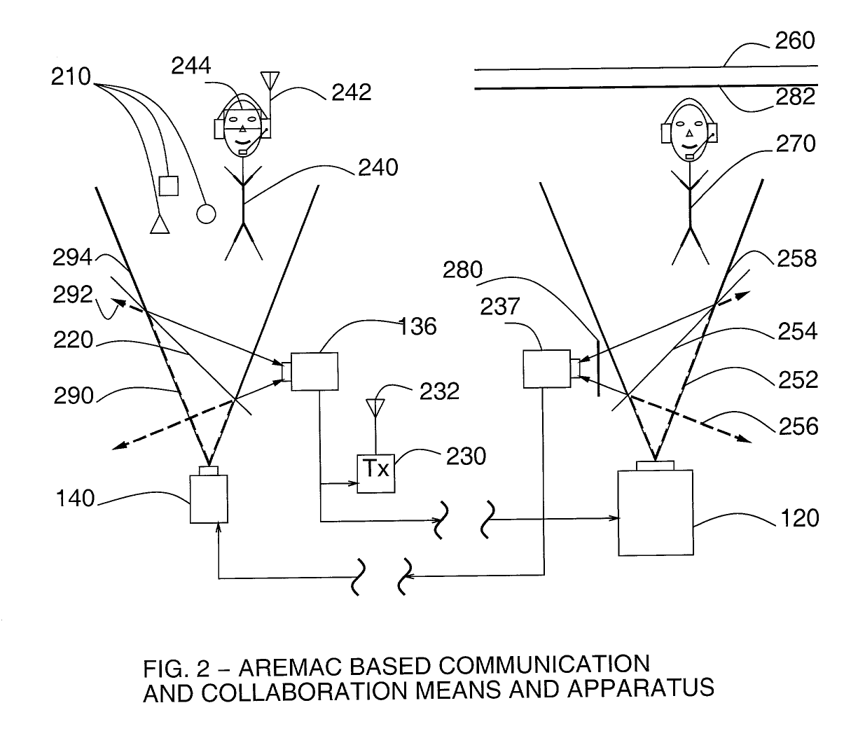

FIG. 2 depicts the aremac 140 as part of a system which facilitates visual communication and collaboration. Without loss of generality, the task described is the photographic process of painting with lightvectors, e.g. walking around in the scene and illuminating various objects in the scene while collaborating with a remote manager. Objects 210 scatter light, typically from artificial light sources such as electronic flash, and a portion of this light is deflected by beamsplitter 220 to camera 136, where an image is recorded and transmitted, typically by a radio transmitter 230, into transmitting antenna 232. A person 240, hereafter referred to as “the photographer” (without loss of generality, e.g. whether or not the task person 240 is engated in is photography), in or near the scene where objects 210 are located receives this signal by way of a body-worn antenna 242, and this signal is displayed on head mounted display 244, so that the photographer can see the objects as they appear from the point of view of camera 136. The signal from camera 136 is also sent by way of another radio transmitter, by telephone lines, computer network, or the like, to a remote, possibly distant location, where it is routed to projector 120. Emanating from projector 120 there are rays of light 252 which reach beamsplitter 254 and are partially reflected as rays 256 which are considered wasted light. However, some of the light from projector 120 will pass through beamsplitter 254 and emerge as light rays 258. The projected image thus appears upon screen 260.

A second person, hereafter, referred to as the photographer's manager or assistant, without intended loss of generality (e.g. regardless of whether the task to which assistance or guidance is being offered is the task of photography or some other task), 270, can observe the scene 210 on screen 260, and can point to objects in the scene 210, by simply pointing to various parts of the screen 260. Camera 237 can also observe the screen 260, by way of beamsplitter 254, and this image of the photographer's manager or assistant 270 pointing at objects in the scene is transmitted back to aremac 140. In order to prevent there from being video feedback, there is, a polarizer 280 in front of camera 237, oriented to pass light from manager 270. Insofar as beamsplitter 254 may or may not fall at exactly Brewster's angle—the angle of maximum polarization, a second polarizer 282 is provided in front of screen 260, whereby polarizers 280, 282, along with the angle of beamsplitter 254 (and correspondingly, keeping camera 237 properly oriented), are adjusted to minimize video feedback, and maximize the quality of the image from manager 270.

The light, 290, emanating from aremac 140, hits beamsplitter 220, and some is lost as waste light 292. The rest of the light, 294, that passes through beamsplitter 220, illuminates the scene 210. Thus photographer 240 sees the image of manager 270 cast upon objects in the scene 210. Although this image of manager 270 will appear disjoint in the photographer's direct view of objects 210, the photographer's view of objects 210 as seen by camera 136, projected into display 244 will appear as a coherent view of manager 270 and gestures such as pointing at particular objects in scene 210. This coherence and continuity of images as seen in display 244 is due to the same principle by which a spotlight operator always sees the circular shape of the spotlight even when projecting onto oblique or disjoint surfaces.

The shared view facilitates collaboration, which is especially effective when combined with a voice communications capability as might be afforded by the use of a wearable hands-free cellular telephone used together with the visual collaboration apparatus. Alternatively, the photographer's portion of the voice communications capability can be built into the head mounted display 244, and share a common data communications link, for example, having voice, video, and data communications routed through a body worn computer system attached to photographer 240 and linked to the system of manager 270 by way of a wireless data communications network.

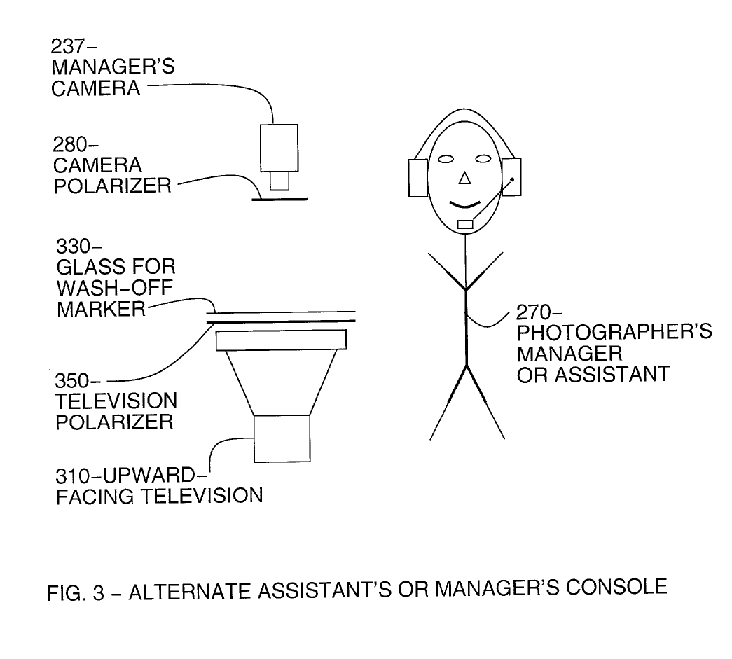

FIG. 3 shows an alternative embodiment of the manager's console in which the manager's display depicting the photographer's scene is a television tube (cathode ray screen) 310 rather than a projection screen. An NTSC television may be satisfactory if the manager has access to a secondary high resolution VGA screen to supplement the material displayed on television 310, but preferably television 310 will itself be a high resolution VGA computer screen having at least 1024 pixels in the up-down direction and 1280 pixels in the across direction.

Television 310 may face in any direction, such as forward or upward, but it is preferable that television 310 face upward so that it may be built into a desk together with a lightbox, viewer for photographic negatives and transparencies, etc., so that electronic images on television 310 can be compared against photographic transparencies, 35 mm slides, and other forms of traditional media, and so that the desk into which television 310 is built may be covered in glass 330 upon which a convenient writing surface will be made. Writing surface 330 may be written upon with nonpermanent markers of the same kind that are used for overhead transparencies, so that manager 270 can annotate images displayed on television 310. Glass 330 preferably extends beyond television 310 to cover a large desk into which a lightbox has been built and calibrated together with television 310 and with calibrated overhead lighting, so that colour balance and intensity will be matched across all three media (electronic image display on television 310, transparency display on the lightbox, and the display of print material placed on the desk) used by manager 270.

The television 310 has a polarizer film 350 which is protected by the glass 330. This polarizer has polarization that is at right angles to the polarizer 280 in front of camera 237. This results in an improved reduction in video feedback by using the console shown here. Whatever the manager 270 writes onto the glass 330 is thus displayed upon the photographer's scene, and is visible to the photographer by way of the photographer's head mounted display.

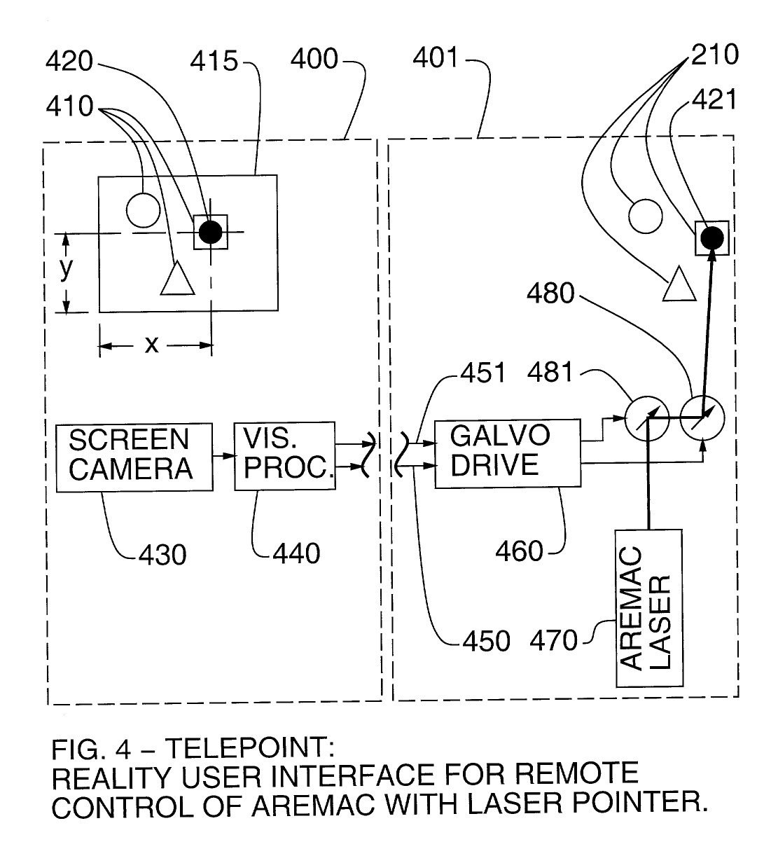

FIG. 4 depicts a manager's office 400 remotely connected to a photographer's studio 401. This connection may be by wire, telephone, radio, satellite communications, fiber optics, or the like. Objects as part of scene 210 in the photographer's studio are seen as objects 410 on a large projection screen 415 at the front of the manager's office. The manager is sitting at a desk, watching the large projection screen 415, and pointing at the large projection screen 415 using a laser pointer. She notices that one of the objects in the scene is slightly out of focus, and not well illuminated, so she points her laser pointer at this object upon screen 415. The laser pointer makes a bright red dot 420 on the screen. A camera 430 in the manager's office points at the screen 415 in such a way that the field of view of camera 430 matches that of the photographer's camera. Since the photographer's camera is displayed on screen 415, camera 430 can easily be made to match this field of view by building camera 430 into the projector that displays on screen 415.

The video signal output of screen camera 430 is connected to a vision processor 440 which simply determines the coordinates of the brightest point in the image seen by camera 430 if there is a dominant brightest point. In actual practice, vision 440 may determine the coordinates of a bright red blob 420 to sub-pixel accuracy. These coordinates as signals 450 and 451 are received at the photographer's studio 401 and are fed to a galvo drive mechanism which controls two galvos. Coordinate signal 450 drives azimuthal galvo 480 while coordinate signal 451 drives elevational galvo 481. These galvos are calibrated by the galvo drive unit 460 so that aremac laser 470 is directed to form a red dot 421 on the object in the photographer's studio 401 that the manager is pointing at from her office 400. Aremac laser 470 together with galvo drive 460 and galvos 480 and 481 together comprise a device called an aremac which may be built into the photographer's camera so that they will be properly calibrated. This aremac may alternatively be housed on the same mounting tripod as the photographer's camera, where the two may be combined by way of beamsplitter.

If it is not practical or desirable to use a beamsplitter, or it is not practical to calibrate the entire apparatus, the manager may use an infrared laser pointer so that she cannot see the dot formed by the laser pointer. In this case, she will look at the image of the red dot that is captured by the photographer's camera so that what is seen by her as dot 420 on screen 415 is by way of her ability to look through the photographer's camera. Note that in all cases, the laser beam in the photographer's studio will be in the visible portion of the spectrum (e.g. red and not infrared). In this way, her very act of pointing will cause her own mind and body to close the feedback loop around any reasonable degree of misalignment or parallax error in the entire system.

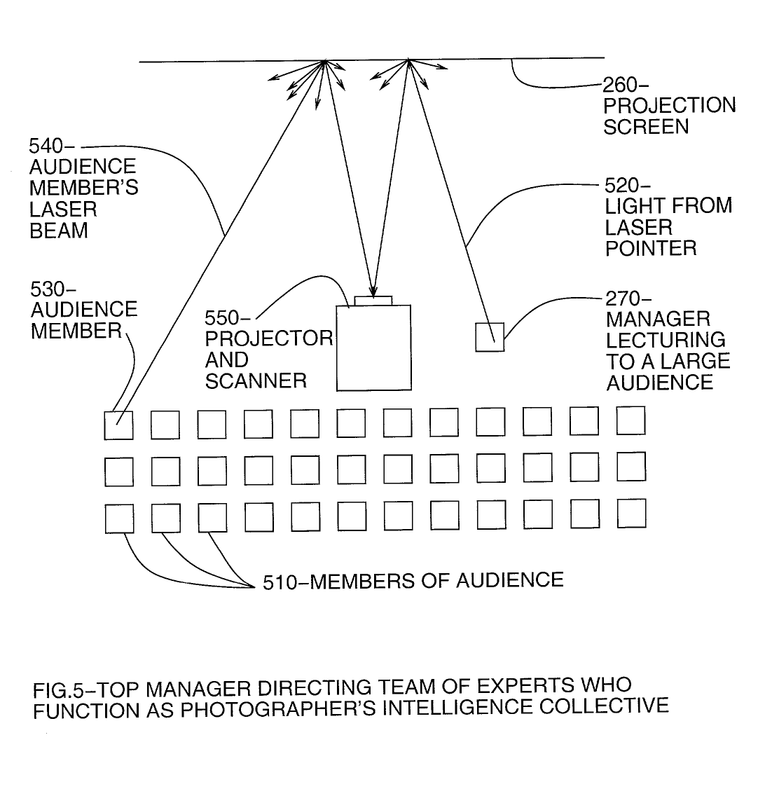

FIG. 5 depicts an intelligence collective for a remote photographer. This apparatus is typically used when the photographer is on-location (e.g. outside his studio) shooting uncooperative or unwilling subjects. An audience comprising legal experts, and other experts, comprise an intelligence collective 510. Typically the photographer's camera is a wearable EyeTap™ video camera so that members of collective 510 can see exactly what the photographer is looking at. (EyeTap cameras record exactly the light rays passing through an eye of the wearer, so what is displayed on screen 260 is exactly what the wearer is seeing).

Members of collective 510 have voice communication (typically only one-way) to the photographer so they can comment on what the photographer is looking at, or they may use RTTY (radio teletype) to display text messages upon the retina of the wearer. (Viewfinders in EyeTap video cameras typically include a directable laser beam that can write upon the retina of the wearer.)

A manager 270 leads this intelligence collective by pointing with laser beam 520 at screen 260 to point at objects on the screen from projector 550. These objects correspond exactly to what is upon the retina of the wearer. The laser beam 520 is seen by the scanner (or camera) inside projector and scanner unit 550. The coordinates of the point at which the laser beam 520 hits the screen 260 are sent to the photographer, and the photorapher's EyeTap eyeglasses cause a laser beam to be directed through the center of the lens of an eye of the photographer onto the retina of an eye of the photographer. In this way, when manager 270 points to an object on screen 260 within the field of view of the photographer, the photographer sees a red dot upon the same object.

Members of the audience may also point at the screen, causing the photographer to see multiple red dots on objects in the scene. Preferably a member of the audience 530 may use a different coloured laser, such as a green laser pointer, and this laser beam 540 may by distinguished from beam 520 by projector and scanner unit 550 so that it can then be encoded and experienced differently by the photographer (e.g. as a green dot upon the retina of an eye of the photographer if the photographer is wearing a colour EyeTap system).

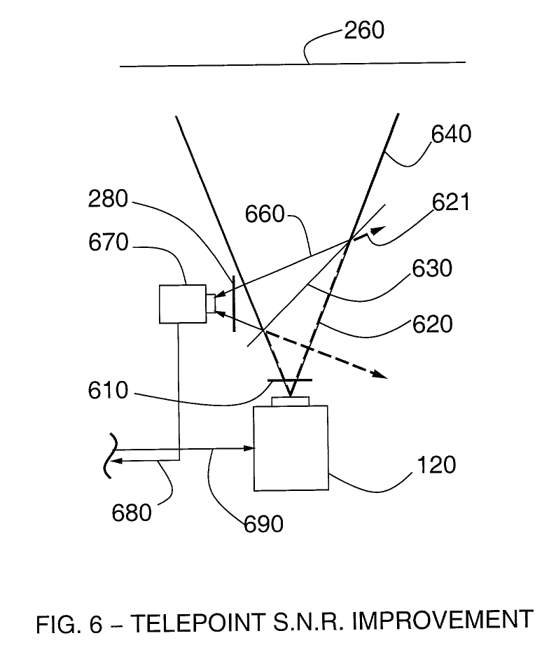

FIG. 6 depicts signal to noise ratio improvement means for a TelePoint (TM) system. A projector 120 projects light through a filter 610. Filter 610 filters out a very narrow band of wavelengths from the white light projection beam. Filter 610 may be a standard laser blocking filter such as those used by pilots during war time to protect their eyes from enemy laser beams. Light 620 that passes through this filter 610 will contain all wavelengths it normally would except a very narrow range of wavelengths corresponding to laser light. In image regions of the projected image corresponding to white objects, light 620 will still be white in appearance since the band of excluded wavelengths is very narrow. Thus filter 610 will not appreciably alter the colour or appearance of objects seen on screen 260.

The beam from the projector 620 is directed to a dichroic beamsplitter 630. Beamsplitter 630 is constructed so that it reflects at the laser wavelength but transmits other wavelengths. Thus any small amount of laser wavelength light that didn't get stopped by filter 610 will be deflected as rays 621 into oblivion (e.g. not hit the screen). In this way, the projection beam at 640 will have had two chances at exclusion of laser wavelength light, one at 610 and the other at 630.

Projected light 640, together with ambient room light (if any), and light from a laser pointer shining on screen 260 will come back to beamsplitter 630. Laser wavelengths of this light will be deflected to scanner (or camera) 670, possibly after passing through anti-feedback polarizer 280 if a polarization feedback prevention means has also been used. The light 660 that enters camera 670 will tend to contain only laser wavelengths on account of beamsplitter 630. Thus the effective gain of the laser pointer detected by scanner 670 is amplified tremendously. In this way, a very low power laser pointer can be used.

Moreover, other forms of Signal to Noise Ratio (S.N.R.) improvement can be implemented, such as the use of a lock-in camera for scanner 670 together with a laser pointer with chopper or modulation. The laser pointer may either transmit a sync signal to the scanner 670 or vice versa (e.g. it may receive a sync signal from scanner 670).

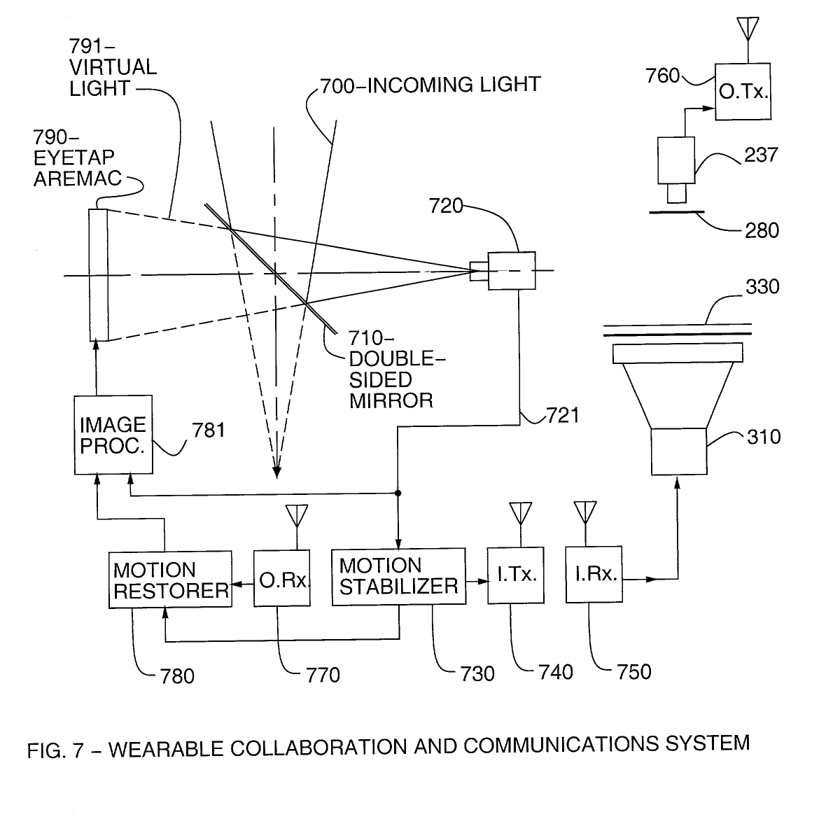

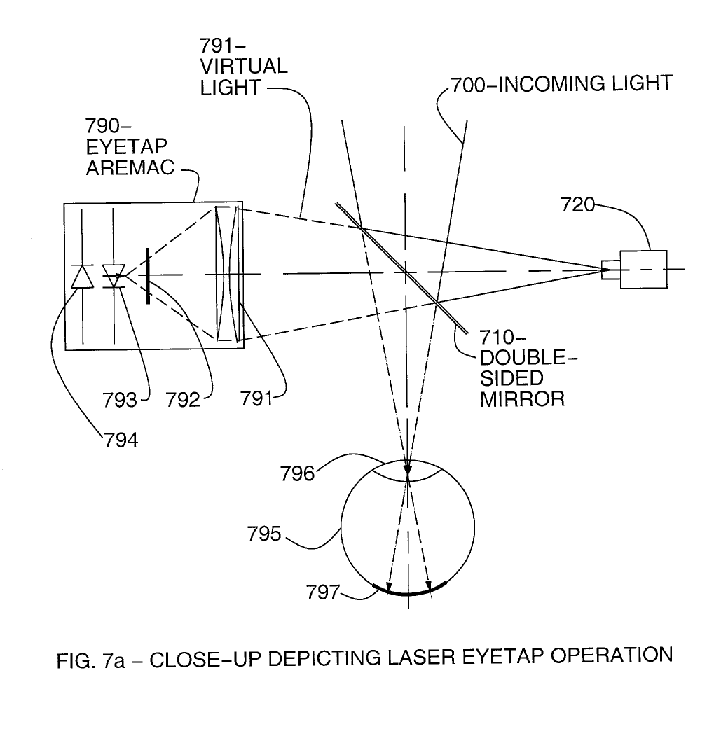

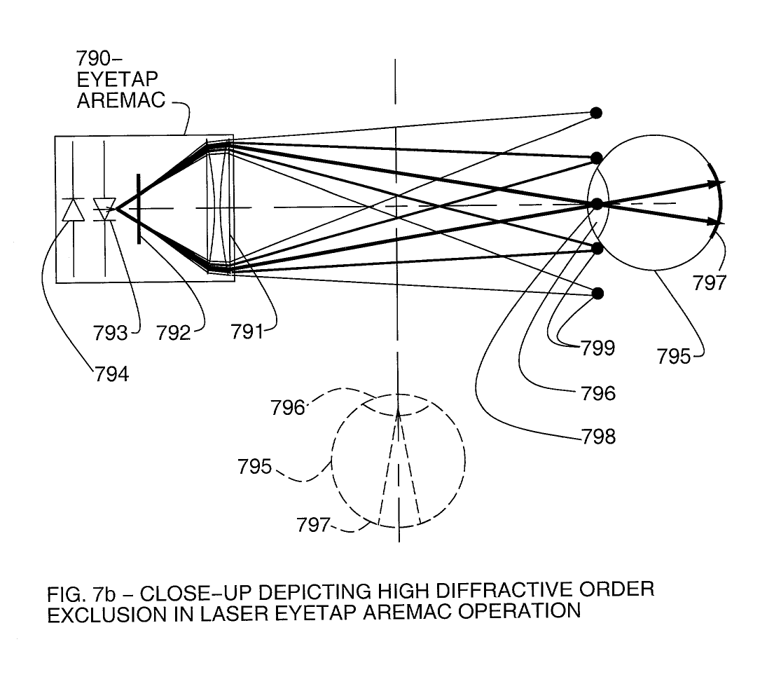

FIG. 7 depicts a wearable version of the photographer's apparatus. Here the photographer's camera is an EyeTap (TM) camera comprising camera 720, double-sided mirror 710, and EyeTap aremac 790 all built within a pair of eyeglasses. EyeTap aremac 790 may be a miniature display means such as a miniature television with a converging lens. A satisfactory television is an LCD screen having size (measured along the diagonal) ranging between ¼ inch and 1 inch. (Sizes of television screens are specified in distance from opposite corners of the rectangular screen as measured along the diagonal in units of inches, where 1 inch is approximately equal to 2.54 centimeters.) Preferably, however, EyeTap aremac will be a spatial light modulator with converging lens in front of it, and a laser diode point source behind it, some distance back, so that it will direct laser light through the center of the lens of an eye of the wearer, and form an image directly upon the retina of an eye of the wearer. In this way, it will function like a display with infinite or near-infinite depth of field. This form of aremac is similar to a pinhole camera in the sense that no matter where the eye's lens is focused, the image formed by the EyeTap aremac will be in sharp focus as seen by an eye of the wearer. Preferably camera 720 will also be a pinhole camera so that the entire apparatus may be sealed within the eyeglass lens material and frames of the eyeglasses and will not have nor need any moving parts as might otherwise be needed to focus the camera or EyeTap aremac.

The pencil of rays of light 700 that would pass through the center of the lens of an eye of the wearer of the apparatus is instead diverted by double-sided mirror 710 to camera 720. Double-sided mirror 710 is thus called a diverter. A diverter may also comprise a beamsplitter, so that a portion of the light is diverted, in which case camera 720 will include video feedback prevention means (polarizer). The diverter may also be curved, for example, so that it will become the optics, or part of the optics used in the EyeTap aremac, and will also become the optics, or part of the optics of camera 720. In general a diverter is a curved or straight mirror or beamsplitter. The entire optical assembly is such that the diverter together with the rest of the optics divert incoming light or a portion thereof to the camera 720, and replace some or all of this light with light from an EyeTap aremac, so that the wearer of the apparatus sees some or all of the image replaced with a possibly unaltered or deliberately altered (computer-mediated) view.

The manner in which this alteration (mediation) of reality by computer or by remote human is achieved is described in what follows. Signal 721 from camera 720 is sent to a motion stabilizer 730. Motion stabilizer 730 sends a stabilized version of the video signal to inbound transmission means 740 where it is sent to the manager's office. The terms inbound and outbound will be used to denote signals sent to and from the manager's office respectively. Thus the manager's office is the hub of activity, and may correspond to more than one roving reporter or photographer.

At the manager's office there is a receiver 750 which receives the stabilized video signal for display on television 310. The manager can annotate the video signal on glass 330, and the annotated signal is seen through video feedback prevention polarizer 280 by camera or scanner 237. This annotated video signal is sent by outbound transmitter 760 back to the photographer.

The annotated video signal from transmitter 760 is received by outbound receiver 770 and sent to a motion restorer 780. Motion restorer 780 undoes the effect of the motion stabilizer so that the annotated images will appear to the photographer to move with his head movements. For the same reason that unstabilized images would make the manager seasick or dizzy, stabilized images would make the photographer seasick or dizzy, since his vestibular cures are those of motion, and thus the images motion should match this vestibular motion.

Some video 721 may go directly from camera 720 into the image processor 781 which combines raw and annotated imagery for display on EyeTap aremac 790.

EyeTap aremac produces converging (virtual) rays of light 791 which are reflected by the other side of double-sided mirror 710 into an eye of the wearer of the apparatus. This is the principle of operation of EyeTap video, in which a portion of the lightspace 700 that would normally be seen without the wearable apparatus has been replaced by a mixture of those exact light rays and synthetic light rays.

FIG. 7a depicts a close-up view of FIG. 7 in which EyeTap aremac 790 and its operation projecting into an eye of the wearer of the apparatus is shown in detail. EyeTap aremac 790 is shown with optics 791 which direct light from L.E.D. (light emitting diode) 793 through spatial light modulator 792. Spatial light modulator 792 may be constructed from a commercially available miniature LCD display, such as the Kopin SmartSlide (TM) by sandwiching the LCD slide between two pieces of glass bonded with index matching epoxy. A test is often made by sandwiching the LCD slide between glass with Xylene index matching fluid to test to see whether or not the selected LCD panel is suitable for use as a spatial light modulator with laser light. L.E.D. 793 is preferably a resonant L.E.D. otherwise known as a “laser diode” (L.D.). This light source 793 functions as a point source and creates a beam that is spatially modulated by spatial light modulator 792 which, together with optics 791 produces rays of light that pass through the center of the lens 796 of an eye 795 of the wearer of the apparatus.

Spatial light modulator (SLM) 792 is fed with a video signal, so that it causes a picture to be imprinted directly upon the retina 797 of an eye of the wearer of the apparatus, regardless of where the wearer's eye lens 796 is focused. In this way, if the wearer looks off to infinity, the image from SLM 792 will seem to hover off in space infinitely distant and infinitely large. If, however, the wearer looks at something very close such as a piece of paper 10 centimeters from his eye, the image from SLM 792 will still be in sharp focus and will appear to hover at a distance of 10 cm from the wearer's eye, since it exists on the retina of the wearer's eye and not actually at any particular point of focus.

Because spatial light modulator 792 is generally made from a periodic lattice of pixels, there will be diffraction, and thus there will be seen at certain points a plurality of images, either distinct or overlapping (depending on eye location) that correspond to what is displayed on SLM 792. However, the optical system is aligned, and the eye is located such that only one period of this lattice is visible, and so that there is no blurring due to this periodicity. Moreover, the periodicity causes a jump in the image as the eye moves around, so there must be very well fitted positioning, such as in eyeglasses through the selection and adjustment of nose pads, to make sure that the central period (the brightest one) is used, since that is the one that is normally aligned to the camera 720 such that the collinearity condition between rays of virtual light entering eye lens 796 and the actual incoming light rays 700.

Optionally, light source 793 is controlled in intensity by the surrounding ambient light level, so that in bright sunlight, the image is written upon the retina with greater amounts of light, while in a darkened room, lesser amounts of light are used. The amount of light needed may be determined photoquantigraphically by analysis of the output and control signals associated with camera 720. Photodiode 794 monitors the amount of output of light source 793 and may be used as part of a feedback look to control the amount of light output from light source 793 in accordance with a desired target quantity of light on retina 797 to match the quantity of light of incoming light rays 700.

FIG. 7b depicts an unrolling of the optical path without diversion (e.g. in which the diverter is taken out of the drawing for clarity). The original eye has been left in, using dotted lines, to depict where the effective eye location is imaged by the diverter (shown in solid lines). Note that the effective eye position corresponds exactly with the camera position. In this way, the eye is effectively positioned where the camera was located, and in fact, the camera is thus effectively positioned inside the eyeball of an eye of the wearer, such that the effective camera center of projection corresponds to the lens of an eye of a wearer.

Point source 793 shines through SLM 792. Each ray of light from this point source produces a central ray denoted by thick lines that meet at 798, after passing through optics 791 to form the point source image at 798. Due to the periodicity of SLM 792 which usually has a discrete lattice of pixels, there is diffraction of this central beam, and the various orders of diffraction are depicted by thinner and thinner lines, as we move in either direction from the central order. These other orders of diffracted rays meet at points 799 which also form point source images if the point source is monochromatic or nearly so (as in laser EyeTap embodiments of the invention). If the point source is broadband then the diffracted rays will not be well defined, and will instead give rise to rainbow source images 799. In the broadband case, only the central point source image 798 will be sharp, but in either case, the central point source image 798 will be the brightest. It is desired that only one of these enter the eye, and in fact it is desired that the clearest and brightest of these enter the eye. Otherwise image “doubling” will result (if two enter the eye), or image multiplicity will result (if more enter the eye) and the image will appear “ghosted”. Elimination of this “ghosting” is one reason that placement of the apparatus on the body of the wearer should be such that eye lens 796 is centered upon point source 798.

An EyeTap aremac in which the image of a point source is imaged onto the center of projection of a lens of the eye is said to meet the EyeTap aremac criterion. The EyeTap aremac criterion may be met with or without the use of a diverter; the criterion simply describes the relationship between a point source, a spatial light modulator, and optics of any sort, whether the optics are a diverter, include a diverter, or do not include a diverter. An apparatus that meets the EyeTap aremac criterion is said to be a means for aremac EyeTapping.

Moreover, the entire apparatus as depicted in FIG. 7a is built so that this alignment of 796 with 798 results in a direct correspondence between the center of projection of camera 720 and 798. A wearable camera system that meets this criterion in which the effective center of projection of the camera (as imaged by the diverter) is located at the center of projection of an eye of the wearer is said to meet the EyeTap camera criterion. The definition of this criterion is irrespective of the the existence of the EyeTap aremac. Thus so long as rays of light from the scene are diverted to a camera in such a way that the bundle of rays that would have passed through the center of projection of the lens of an eye of the wearer in the absence of the apparatus, are diverted through the center of projection of the camera, then the camera is said to meet the EyeTap camera criterion. An apparatus that meets the EyeTap camera criterion is said to be an EyeTapping camera means.

As shown in FIG. 7b, an eye of the wearer is effectively located where the camera is, or equivalently, the optical arrangement is such that the camera is effectively located inside an eyeball of the wearer, with the center of projection of the camera effectively located in the center of the lens of an eye of the wearer. Thus FIG. 7b is a good depiction of an example of an EyeTapping camera means as well as an EyeTapping aremac means.

When an apparatus meets both the EyeTap aremac criterion and the EyeTap camera criterion, it is said to meet the EyeTap criterion. Thus the apparatus depicted in FIG. 7, and detailed in FIG. 7a and FIG. 7b is an example of a means of EyeTapping. A camera EyeTapping means together with an aremac EyeTapping means is referred to as an EyeTapping means.

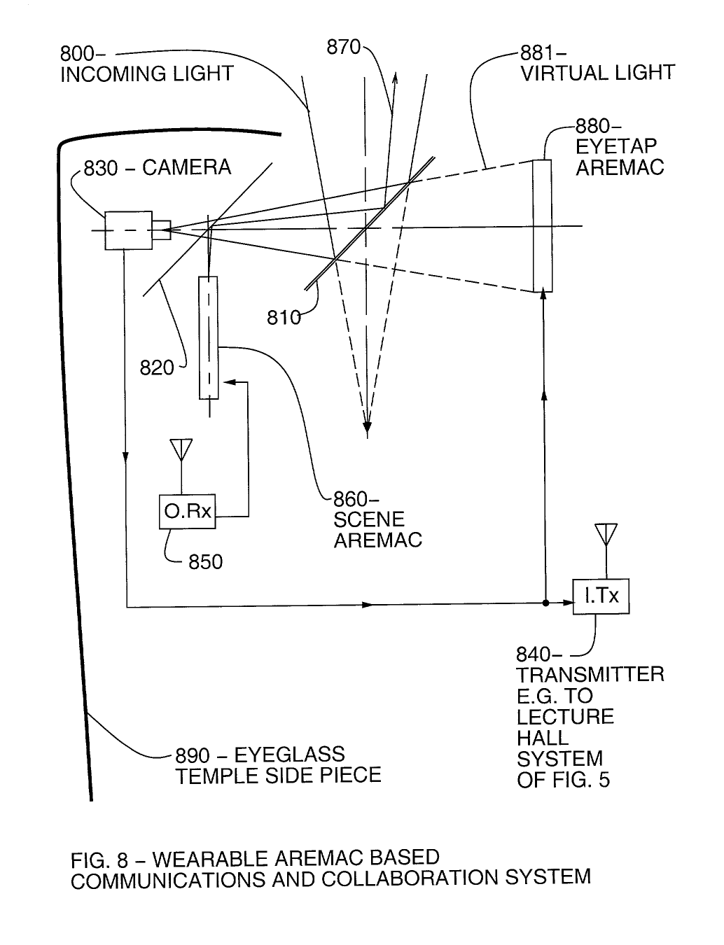

FIG. 8 depicts a pair of eyeglasses containing two aremacs, an EyeTap aremac which directs light onto the retina of an eye of the wearer, and a scene aremac which directs laser light onto the scene in front of the wearer.

A portion 800 of the field of view that the wearer would normally see in the absence of the apparatus is deflected by two-sided mirror 810 to camera 830. (Two-sided mirror 810 may be replaced with a beamsplitter if camera 830 and EyeTap aremac 880 each include a polarizer to prevent video feedback.) The video signal from camera 830 is transmitted to one or more remote managers by transmitter 840.

One or more remote managers may point at an object in the scene either with a traditional mouse cursor, or with a TelePoint (TM) remote laser pointer system previously described. In either case, the result is that scene aremac 860 picks up signals from one or more remote managers by way of radio receiver 850. These signals steer the beam which emerges as ray 870 and points at the object(s) that the one or more remote managers are pointing at.

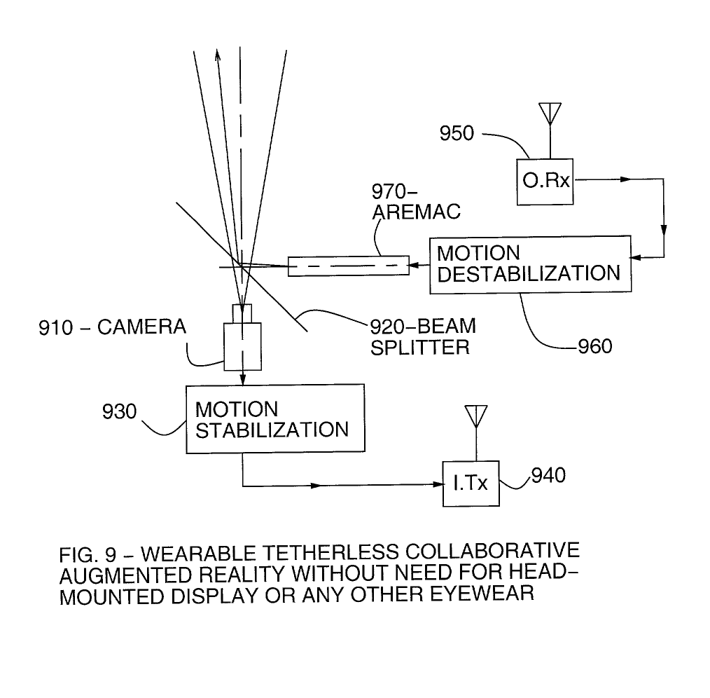

FIG. 9 depicts a portable hand-held or wearable embodiment of the invention which does not need to be worn upon the head where it would cover eye of the user. Camera 910 which views the scene through beamsplitter 920 sends video to a motion stabilization system 930. The stabilized video signal from stabilization system 930 is sent to a remote director by inbound transmitter 940. At a remote location, the remote director displays video received from transmitter 940 on a large screen video projector. The remote director points to objects in the scene by pointing at the screen with a laser pointer. A scanner in the director's office scans the screen to determine where the director is pointing, and these coordinates are sent back to be received by outbound receiver 950. These coordinates are converted back to the same coordinates as the camera 910. This conversion process is done by motion destabilizer 960 which does the inverse operation of what the motion stabilizer 930 does, possibly with a time lag (e.g. undoes what the motion stabilizer recently did). The coordinates, in destabilized form (e.g. in the coordinates of camera 910) direct aremac 970 to point at the corresponding object in the scene. Thus when the remote director points at an object on her screen, by using her laser pointer, the same object appears to the photographer as having a red dot appear upon that object at the same location.

Thus, for example, if a remote spouse is remotely watching what her husband is pointing the apparatus at, she can see the video on her screen, and point at an object in view of the camera, causing aremac 970 to point at this object. This functionality (teleoperation of a laser pointer with a laser pointer as an input device) is called telepointing, and the apparatus shown in FIG. 9 is an example of a telepointing means.

Typically, the apparatus of FIG. 9 will be housed inside a cellular telephone which becomes the communications channel 940 and 950. This facilitates voice communication, and allows the photogrpaher to point the camera at objects in the scene, where, for example, a remote spouse can telepoint to objects such as one of the levers on the steering column of a new car that her husband is shopping for.

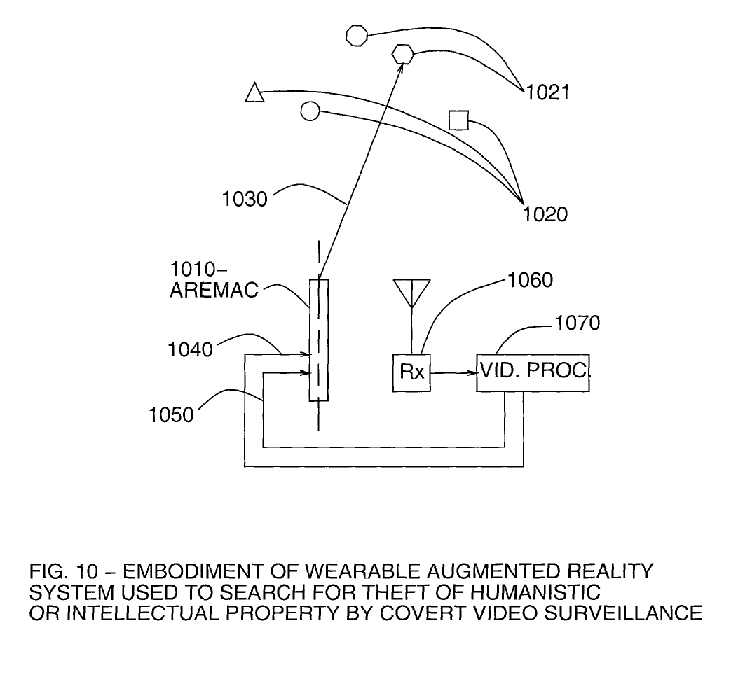

FIG. 10 depicts an embodiment of the wearable augmented reality system that may be used to automate the process of pointing the aremac at the object of interest. Normally the aremac is is operated by a remote director using a telepointing process, but here the situation is such that the aremac points itself directly at the object of interest. An aremac 1010 is worn upon eyeglasses, or carried by the user, and is pointed into an area in which there is suspected theft of intellectual property of humanistic property by way of covert video surveillance. For example, the system might be used by an inventor or patent attorney meeting in a resturant or hotel room to discuss a patent. Prior to spreading the drawings out on the table of a rented space, either party may scan the space with the aremac where 1020 are ordinary objects and 1021 are objects such as smoke detectors, black signage, clocks with black or mirrored panels, or the like, in which there are hidden video surveillance cameras.

The aremac, by default, scans in a raster or double sinusoidal pattern, illuminating a large number of objects with a small red blob in motion. A very sensitive receiver 1060 is tuned to pick up any quasi-periodic or near cyclostationary signal that has the form of a television signal. Video surveillance detection processor 1070 is driven by this signal, and it drives galvos in the aremac 1010 by way of control signals 1040 and 1050.

Ordinarily it is very hard to distinguish video surveillance signals from other television signals such as might arise from people in the hotel room next door watching a rented movie, or from televisions in restaurants that are tuned to commercial broadcast frequencies. However, video surveillance detection processor 1070 is built to function like a lock-in amplifier and it detects the change in the signal due to the modulation of the laser beam 1030. If the suspected video surveillance signal varies in response to the intensity of beam 1030 upon the suspected object, then there is a high possibility of theft of intellectual property or humanistic property.

The system first determines in a very sensitive way, coordinates where theft is suspected. Then it narrows the search by directing the beam to only those areas. Suppose, for example, that it determines that two objects 1021 are suspect. It tests these by tracking them (pointing the beam at them) for extended periods, instead of merely when the raster or scan passes over them. Thus once the whole room has been scanned, scanning is reduced to only these two objects. By using signal averaging, over many periods of the video signal, video surveillance detection processor 1070 functions in the manner of a lock in amplifier to obtain more than 120 dB of gain above raster scan mode. Thus even if the perpetrators of the attempted theft attempt to shield the cameras in copper foil, the theft will still be detected.

A wearable embodiment of the aremac pointing apparatus is particularly useful when scanning a large room for theft. Hidden surveillance cameras are pinpointed by the red dot that remains hovering over the point of surveillance. What is found is the effective optical center of projection of the lens of the surveillance system. Thus even if the camera is well hidden, for example, in a sprinkler head, the optics (for example, the mirror in the sprinkler head) will be pinpointed rapidly.

The system is also easy to use for anyone who has used the telepointer embodiments of the invention, since it works exactly the same way. The red dot points to the object of interest, just as if an all-knowing remote director were pointing out the location of each of the hidden surveillance cameras to the wearer of the apparatus.

The apparatus of FIG. 10 may also include a camera and transmitter so that a remote director can witness the evidence of the theft. Alternatively, the apparatus may contain a camera with local storage so that the wearer can collect evidence of the theft. In this way, the apparatus serves as a photographer's assistant, where the aremac helps point the way to subject matter to be photographed.

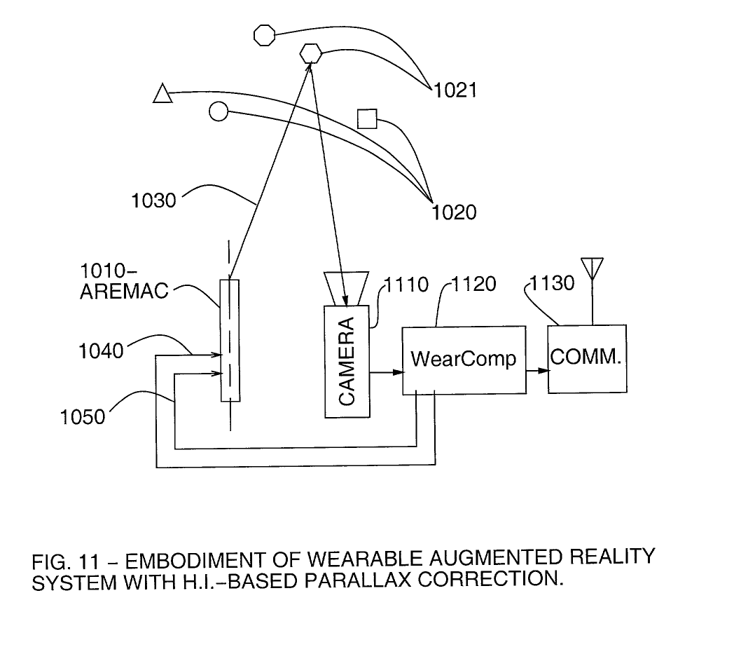

FIG. 11 depicts an embodiment of the telepoint aremac control apparatus in which there is parallax between camera and aremac and in which humanistic intelligence (HI) is used to correct for this parallax. In this embodiment, camera 1110, which is often mounted in the nose bridge of a pair of eyeglasses, sends pictures to one or more remote directors by way of a wearable computer (WearComp) 1120 and radio transmitter+receiver (transceiver) 1130. The remote director uses an infrared laser pointer to point at a screen upon which is projected the signal from camera 11110. The infrared laser pointer forms a blob of light invisible to the director, but visible to an infrared scanner scanning the screen in the director's office. The coordinates where the laser pointer forms a blob of light on the screen in the director's office are determined by the scanner in the director's office connected to a machine vision system, and these coordinates are received by transceiver 1130. WearComp 1120 takes these coordinates and uses this information to control aremac 1010 by way of control signal lines 1040 and 1050. It should be noted that even though there may be considerable parallax between camera 1110 and aremac 1010, the process of telepointing involves a remote human being in the feedback loop of the process, so that the correspondence between remotely selected object and locally seen object pointed at will be made. For example, if camera 1110 is in the nose bridge of a pair of eyeglasses and aremac 1010 is on one side of the glasses (e.g. on a temple side piece), there will be some parallax that can easily be accounted for.

Even if aremac 1010 were located in a waist pouch (“belly bag”) the parallax will still be compensated for by humanistic intelligence. The director's laser beam is invisible to the director, but controls a visible cursor on the screen in the director's office. The screen is a computer screen displaying the VGA signal associated with WearComp 1120 including the video of camera 1110. The coordinates of this cursor are determined by camera 1110 detecting and tracking the laser beam from aremac 1010. When the laser beam from aremac 1010 is not visible by camera 1110, then the cursor will disappear. Suppose, for example, that the wearer is selecting fruits and vegetables in the grocery store, and the director is a remote spouse who points to an object on the shelf. If the beam is not visible to the wearer, it will also be invisible to the director. Thus the director will instinctively move the pointer around a little, until the cursor becomes visible, just as we instinctively move the mouse of a computer around until we can “find” the cursor if the cursor is hidden from view. Thus the director will move the pointer around a little until she can see the cursor on her screen. When she can see the cursor, so can the wearer of the apparatus. The wearer of the apparatus will see the actual laser beam pointing at some object within his field of view whenever the director can also see the cursor on her screen.

The apparatus of this invention allows a photographer to be remotely visually connected to a remote director, over a long period of time, with virtually no eyestrain. For example, after wearing the apparatus sixteen hours per day for several weeks, it begins to function as a true extension of the mind and body. In this way, photographic composition is much more optimal, because the act of taking pictures or shooting video no longer requires conscious thought or effort.

The apparatus of the invention also allows the photographer to allow others to share his experience. The photographer may also allow others to partially alter his perception of reality. In this way the invention is useful as a new communications medium, in the context of collaborative photography, collaborative videography, and telepresence. Moreover, the invention may perform other useful tasks such as functioning as a personal safety device, crime deterrent, or visual communications device by virtue of its ability to summon the advice or assistance of one or more remote experts.

From the foregoing description, it will thus be evident that the present invention provides a design for an infinite depth of focus camera view annotation means. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications, if within the spirit of this invention, are intended to be encompassed within the scope of any claims to patent protection issuing upon this invention.

I claim as my invention:

1. A photographer's assistant system where said system includes a head-worn display means where said display means is responsive to the output of a camera fixed in the immediate vicinity of the wearer of said display means, and where said system further includes a scene aremac, where said scene aremac is fixed in the immediate vicinity of the wearer of said display means.

2. A photographer's assistant system as described in claim 1 where said camera and said scene aremac share a common effective center of projection.

3. A photographer's assistant system as described in claim 1 where said scene aremac is responsive to a remote entity.

4. A photographer's assistant system as described in claim 1 where said scene aremac is responsive to a telepointer operated by an individual at a remote location.

5. A director's assistant system where said director's assistant system includes communication means with a studio where said studio contains a camera and a scene aremac, where the director of said director's assistant system has means for projection of the output of said camera onto a screen, and means for scanning said projection upon said screen together with a blob of light from a laser pointer when said blob of light is incident upon said screen.

6. A director's assistant system as described in claim 5 where said director's assistant system further includes means for determining the coordinates of said blob of light upon said screen.

7. A director's assistant system as described in claim 6 where said director's assistant system further includes means for driving said scene aremac where said means for driving said scene aremac is responsive to said coordinates.

8. A director's assistant system as described in claim 7 where said director may point with a laser pointer at objects on the screen, and where said director's assistant system includes means for scene aremac tracking where said means for scene aremac tracking includes means for matching approximately the location of the blob of light made by said aremac on the scene in front of said camera with the blob of light made by said red laser pointer, where said matching is in the image coordinates of said camera.

9. A director's assistant system as described in claim 8 where said laser pointer is a red laser pointer, and where said aremac includes a red laser with galvos controlling the position of the beam of said red laser.

10. A director's assistant system as described in claim 8 where said laser pointer is an infrared laser pointer, and where said aremac includes a red laser with galvos controlling the position of the beam of said red laser.

11. A telepointer aremac control system where said system includes a screenspace, a workspace, and means of communication between said screenspace and said workspace, where said workspace includes a camera and an aremac, and where said screenspace includes a screen and scanner of said screen where said screen may display the output of said camera, and where said scanner may scan said screen to determine the location upon said screen where a laser pointer is pointing, and where said telepointer aremac control system also includes means of controlling said aremac where said means of controlling said aremac includes means of aiming said aremac at a point in the scene before said camera where said means of aiming said aremac includes means of matching said point in said scene with the corresponding point on said screen selected by the pointing of a laser pointer at said screen.

12. A laser-based aremac system tele-operated by a laser pointer to facilitate communication between a first conferee using the laser pointer and a second conferee, at a remote location, working on objects in front of the laser-based aremac system, the laser-based aremac system comprising:
a housing to be located in the workspace of said first conferee;
camera enclosed in said housing;
image capture means for said camera,
laser-based aremac enclosed in said housing;
communications channel between said first conferee and said second conferee, said communications channel including means of display of an image from said image capture means upon a screen in view of said first conferee;
means of scanning said screen to detect the presence of a laser pointer aimed at said screen, and in the presence of a laser pointer aimed at said screen, to determine the coordinates where on said screen said laser pointer is pointing;
means of pointing said laser-based aremac at a location in said workspace corresponding to the location on said image where said second conversee is pointing.

13. A laser-based aremac system as described in claim 12 further including a beamsplitter where said beamsplitter combines said camera and said laser-based aremac to share a common center of projection.

14. A laser-based aremac system as described in claim 13 where said beamsplitter transmits only a narrow band of wavelengths in which said laser-based aremac operates, and where said beamsplitter reflects all other wavelengths.

15. A laser-based aremac system as described in claim 13 where said beamsplitter reflects only a narrow band of wavelengths in which said laser-based aremac operates, and where said beamsplitter transmits all other wavelengths.

16. An EyeTap aremac where said EyeTap aremac includes a point source of light, a spatial light modulator, and optics where said optics form an image of said point source of light in the lens of an eye of the user of said EyeTap aremac, and where said spatial light modulator is responsive to a video input signal.

17. An EyeTap aremac as described in claim 16 where said EyeTap aremac is wearable.

18. An EyeTap aremac as described in claim 17 where said EyeTap aremac is responsive to a signal from a remote director.

19. An EyeTap aremac as described in claim 16 further including means of positioning said EyeTap with respect to said eye to prevent higher diffractive orders from entering said eye.

20. An EyeTap aremac as described in claim 16 further including means of preventing all higher diffractive orders from entering said eye, other than the central brightest zeroith order.

21. An EyeTap aremac as described in claim 17 further including a camera.

22. An EyeTap aremac as described in claim 21 where said EyeTap aremac is responsive to a signal from a remote director, where said remote director may view a display medium responsive to said camera.

23. An EyeTap aremac as described in claim 17 further including camera EyeTapping means.

24. An EyeTap aremac as described in claim 17 further including camera EyeTapping means where said EyeTap aremac displays a signal indicative of the spatial variation in exposure across the image of the camera providing said camera EyeTapping means.

25. An EyeTap aremac as described in claim 17 where said EyeTap aremac is head-mountable.

26. An EyeTap aremac as described in claim 17 where said EyeTap aremac is built into eyeglasses.

27. An EyeTap aremac as described in claim 26 where said optics is built into a lens of a pair of said eyeglasses.

28. An EyeTap aremac as described in claim 27 where said optics includes a diverter.

29. An EyeTap aremac as described in claim 28 where said diverter is a dichroic beamsplitter.

30. An EyeTap aremac as described in claim 17 further including a camera and two-sided mirror where said camera is aligned with optical axis collinear to an optical axis defined by said point source and the center of said spatial light modulator and where said two-sided mirror forms an angle with said optical axis where said angle is not equal to an integer multiple of pi/2 and where said image is formed by reflection from one side of said two-sided mirror, and where said camera receives a picture by way of reflection from the other side of said two sided mirror.

31. An EyeTap aremac as described in claim 17 further including a camera and beamsplitter where said camera is aligned with optical axis collinear to an optical axis defined by said point source and the center of said spatial light modulator and where said beamsplitter forms an angle with said optical axis where said angle is not equal to an integer multiple of pi/2 and where said image is formed by reflection from one side of said beamsplitter, and where said camera receives a picture by way of reflection from the other side of said beamsplitter, and where said EyeTap aremac further includes video feedback prevention means.

32. An EyeTap aremac as described in claim 16 where said point source of light is a light emitting diode.

33. An EyeTap aremac as described in claim 32 where said light emitting diode is a resonant light emitting diode.

34. An EyeTap aremac as described in claim 32 where said light emitting diode is a laser diode.

35. An EyeTap aremac as described in claim 32 where said light emitting diode is a laser diode and where said spatial light modulator is an LCD panel, and where said LCD panel is oriented so that the polarization orientation of the side facing said light emitting diode matches the polarization of said light emitting diode.

36. An EyeTap aremac as described in claim 35 where said spatial light modulator is not square but has rectangular shape and where said laser diode is oriented with major axis of light output aligned along the length of said rectangular shape and where said laser diode is oriented with minor axis of light output along the width of said rectangular shape.

37. An EyeTap aremac as described in claim 36 further including a dichroic beamsplitter as described in claim 29.

38. A wearable camera system including camera and body-worn recording means, where said wearable camera system further includes camera EyeTapping means.

39. A wearable camera system as described in claim 38 further including an aremac and aremac EyeTapping means.

40. A wearable camera system as described in claim 39 where said aremac is responsive to at least one individual at a remote location, and where said at least one individual has image display means where said image display means is responsive to an output from said camera.

41. A wearable camera system as described in claim 38 where said camera EyeTapping means includes a diverter.

42. A wearable camera system as described in claim 38 where said wearable camera system includes EyeTapping means.

43. A wearable camera system including camera, spatial light modulator, and diverter, where said wearable camera system includes camera EyeTapping means.

44. A wearable camera system as described in claim 43 where said spatial light modulator is responsive to a video signal derived from said camera.

45. A wearable camera system as described in claim 43 where said spatial light modulator is responsive to a video signal derived from a director at a remote location, and where said director has means of display responsive to an output of said camera.

46. A wearable camera system as described in claim 43 where said spatial light modulator is responsive to a video signal from a remote entity, where said remote entity is responsive to a video signal derived from said camera.

47. A wearable camera system as described in claim 46 where said remote entity is an intelligence collective.

48. A wearable camera system as described in claim 46 where said remote entity includes a person operating a telepointer where said telepointer includes the display of said video signal.

49. A wearable videoconferencing system to facilitate communication between a first conferee wearing a camera and at least one other conferee at a remote location using a laser pointer as a communications aid, said wearable videoconferencing system comprising:
a laser-based aremac wearable by said first conferee;
a projector used by said at least one other conferee, said projector displaying an image from said camera, said image displayed upon a screen visible to said at least one other conferee;
scanning means to detect the use of a laser pointer on said screen, said scanning means including means of determining the location on said screen being pointed to;
data communications means between said scanning means and said aremac, such that said at least on other conferee can point to objects which said first conferee can see by way of said aremac.
A wearable videoconferencing system as described in claim 49 where said laser-based aremac is a scene aremac.
A wearable videoconferencing system as described in claim 49 where said laser-based aremac is an aremac EyeTapping means.
A wearable videoconferencing system as described in claim 49 further including an intelligence collective.

50. Telepointing means, where said telepointing means includes a camera, a motion stabilizer, an aremac, and a motion restorer.
